(19) United States
(12) Patent Application Publication
(10) Pub. No.: US 2016/0209908 A1
(43) Pub. Date: Jul. 21, 2016

(54) CLOUD-BASED INTEGRATED SYSTEM FOR DEVELOPING AND EVALUATING ENERGY EFFICIENT SOFTWARE

(71) Applicant: Texas State University, San Marcos, TX (US)

(72) Inventors: Ziliang Zong, Austin, TX (US); Qijun Gu, Austin, TX (US)

(21) Appl. No.: 14/930,492

(22) Filed: Nov. 2, 2015

Related U.S. Application Data
(60) Provisional application No. 62/122,845, filed on Oct. 31, 2014.

(51) Int. Cl. G06F 1/32; G06F 9/445

(52) U.S. Cl. CPC G06F 1/3234; G06F 1/3206; G06F 8/60

(57) ABSTRACT

A system for developing software includes one or more software development computing systems, one or more power measurement systems, a data collection system coupled to the power measurement system, and an energy efficiency evaluation system. Each of the one or more software development computing systems executes sets of program instructions. The power measurement systems include sensors that measure characteristics associated with electrical power consumption by components of the software development computing systems during execution of sets of program instructions. An energy efficiency evaluation system provides a measure of efficiency (e.g., the amount of energy used to execute set of program instructions) of execution of the sets of program instructions executed on the software development computing systems based on power information from the power data collection systems. The system may include a hardware layer, a power profile layer, and a cloud programming layer. The cloud programming layer supports users editing, compiling, and/or running, by way of a web browser, sets of program instructions on the software development computing systems.

### PRIORITY CLAIM

This application claims priority to U.S. Provisional Application Ser. No. 62/122,845, entitled “Cloud Based Integrated Framework for Developing and Evaluating Energy Efficient Software”, filed Oct. 31, 2014, which is incorporated herein by reference in its entirety.

### STATEMENT REGARDING FEDERALLY SPONSORED RESEARCH OR DEVELOPMENT

This invention was made with government support under Grant No. 1305359, Marcher—A Heterogeneous High-Performance Computing Infrastructure for Research and Education in Green Computing, awarded by the National Science Foundation. The government has certain rights in the invention.

### BACKGROUND

1. Field

The present invention relates to the field of software development and computing system efficiency. More particularly, the present invention relates to the systems and processes for evaluating energy efficiency of software.

2. Description of the Related Art

Current software is often written with little regard to power usage. Some of the largest costs upon deployment are, however, in the power consumption and cooling requirements of the computers that run the software. This hidden cost is often overlooked by decision makers.

Software developers often have not had adequate tools for obtaining power information of software, evaluating the energy efficiency of software, or getting training of developing energy-efficient software. Moreover, existing systems and software development models may not integrate power factors in the life cycle of software development.

In recent years, battery life of mobile devices has become increasingly important, yet the lack of easy-to-use power measurement and power reporting systems and tools for profiling and diagnosing energy consumption of mobile applications hinders the improvement of battery life.

### SUMMARY

Systems and methods for developing software, developing power profiles for software, and an assessing energy efficiency of software are described. In an embodiment, a system for developing software includes one or more software development computing systems, one or more power measurement systems, a data collection system coupled to the power measurement system, and an energy efficiency evaluation system. Each of the one or more software development computing systems executes sets of program instructions. The power measurement systems include sensors that measure characteristics associated with electrical power consumption by components of the software development computing systems during execution of sets of program instructions. The power data collection system collects power information from the power measurement systems. An energy efficiency evaluation system provides a measure of efficiency (e.g., the amount of energy used to execute set of program instructions) of execution of the sets of program instructions executed on the software development computing systems based on power information from the power data collection systems. The system may include a hardware layer, a power profile layer, and a cloud programming layer. The cloud programming layer support users editing, compiling, and/or running, by way of a web browser, sets of program instructions on the software development computing systems.

In an embodiment, a system includes a power measurement system and a power profile generator. The power measurement system includes measuring devices that measure electrical power consumption during execution of a set of program instructions (e.g., a computer program or a block of code) on a computing system. The power profile generator receives measurements of power consumption information by the computing system during execution of the set of program instructions and generates a power profile based on the measurements.

In an embodiment, a method of assessing energy efficiency of executing software: measuring, by one or more power measurement systems coupled to a computing system, one or more characteristics of electrical power consumed by devices during execution of a set of program instructions a computing systems; and determining, based on the measurements, a power profile associated with the execution of the set of program instructions by the computing systems. The power profile may include the energy consumed by execution of the set of instructions.

### BRIEF DESCRIPTION OF THE DRAWINGS

FIG. 1 illustrates one embodiment of a system for developing software including a hardware layer, a power profiling layer, and a cloud programming layer.

FIG. 2 illustrates one embodiment of a user screen display Ibr compiling and executing software,

FIG. 3 illustrates one embodiment of a user screen display for managing, displaying, and retrieving code submissions.

FIG. 4 illustrates one embodiment of a user screen display for displaying and managing code submissions, including favorite submissions.

FIG. 5 illustrates one embodiment of a user screen display for assessing energy efficiency of software.

FIG. 6 illustrates one embodiment of network-based system for assessing software energy efficiency.

FIG. 7 illustrates one embodiment of a power data acquisition device.

FIG. 8 illustrates one embodiment of a cloud computing system that can be implemented to develop software, generate power profiles of software, and assess energy efficiency of software.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In various embodiments, a system evaluates the energy efficiency of software and allows programmers to obtain power information of software from virtually anywhere. Educators may use the system to teach green computing related topics with hands on experiences.

Using the systems as described herein, software developers are not required to learn various power measurement tools. Programmers edit, compile, and execute code to obtain accurate and detailed power information about their code through a web browser. Since web browsers are available on most devices, even users without any background on power measurement can get immediate feedback on the energy consumption of their code from anywhere with a network connection at any time. In some embodiments, the system delivers power profiling as a service.

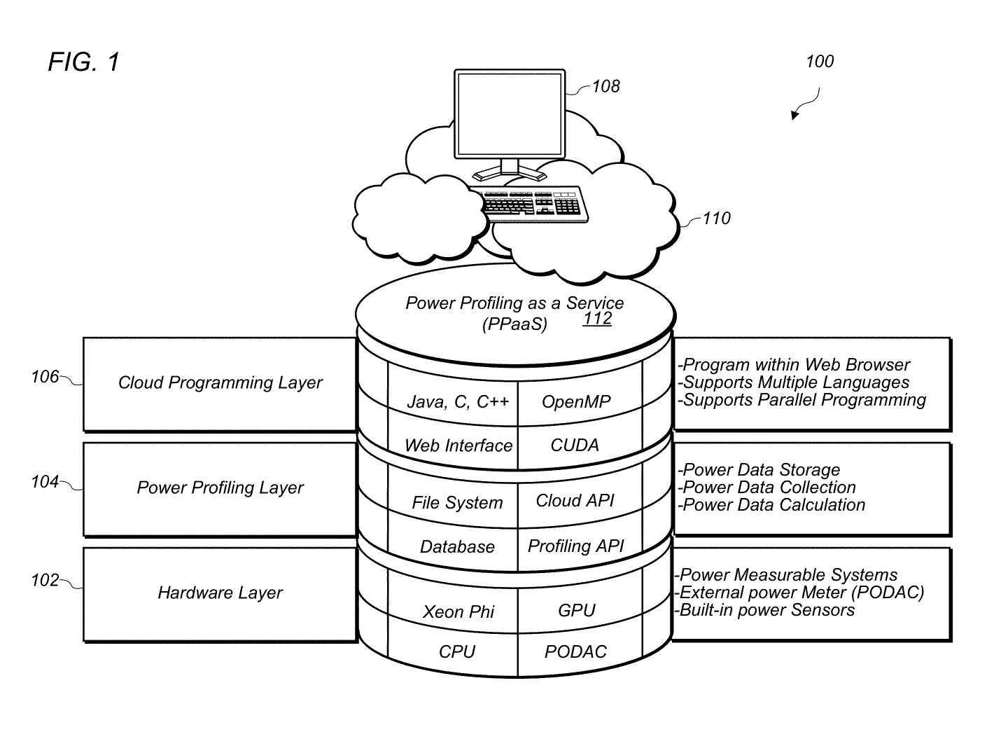

In some embodiments, a system for developing software implements a three-layer framework including a hardware layer, a power profile layer, and a cloud programming layer. FIG. 1 illustrates one embodiment of a system implemented in a hardware layer, a power profile layer, and a cloud programming layer. System 100 includes hardware layer 102, power profile layer 104, and cloud computing layer 106. Programmers may use user systems 108 to receive information from and control components sub-systems and devices in hardware layer 102, power profile layer 104, and cloud computing layer 106.

Hardware layer 102 includes computer systems with power measurement capabilities. The hardware layer may include a power data acquisition card, in combination with data from on-board sensors. Power information of all major components of a compute node (in this example, CPU, DRAM, Disks, GPU, Xeon Phi) may be obtained and decomposed. A collection tool may be used to combine the power data from various sources (e.g. CPU, DRAM, Disks, GPU, and Xeon Phi).

Power profiling layer 104 includes a system for controlling the power profiling meters (e.g., to start, monitor, and stop the meters), collecting, synchronizing, and transferring profile data, as well as communicating with the cloud programming layer via standard HTTP interfaces and Cloud APIs. The profiled power data is stored in a central database or a distributed file system. Power profiling may be automated based on user-specified inputs and parameters. In some embodiments, a power profile system performs power data collection, power data calculations, and power data storage.

The Cloud API is responsible for allocating incoming requests from the web browser for execution by following certain scheduling policies. In one embodiment, the Cloud API manages one or multiple queues, schedules the jobs in the queue to one or more qualified. compute nodes for execution, initiates/stops the power meters to generate power data, and notifies users when the power data are ready. The framework supports a variety of programming languages and programming models. The framework also may employ a set of security measures to ensure the privacy of users' code and data as well as protect the framework from various threats that target the computing resources. By way of the power meter control and profiling software, may be implemented “Power Profiling as A Service” possible. In certain embodiments, the power profile is based on iterative power measurement.

Cloud programming layer 106 is the interface between users and the power measurable systems. Cloud programming layer 106 provides a standard web interface for users to edit, compile, and submit their code to the Cloud API. Once a submission has completed, the interface may be used to display textual and graphical results on performance, energy, and power to the user for analysis. Frontend and backend tools are used to allow software developers to edit, compile and run various code (e.g. serial, CUDA, OpenMP). The code may be written in any of various languages within a web browser (e.g., Mozilla Firefox, Google Chrome, and Safari).

In some embodiments, users can edit, compile, and submit their code in a cloud programming environment. The performance and power results of running user's software may be displayed textually and graphically to users. To enable both online and offline analysis, users can save the power results in the cloud or download the power results to local computers. Users will also be able to compare different optimizations based on the supported metric.

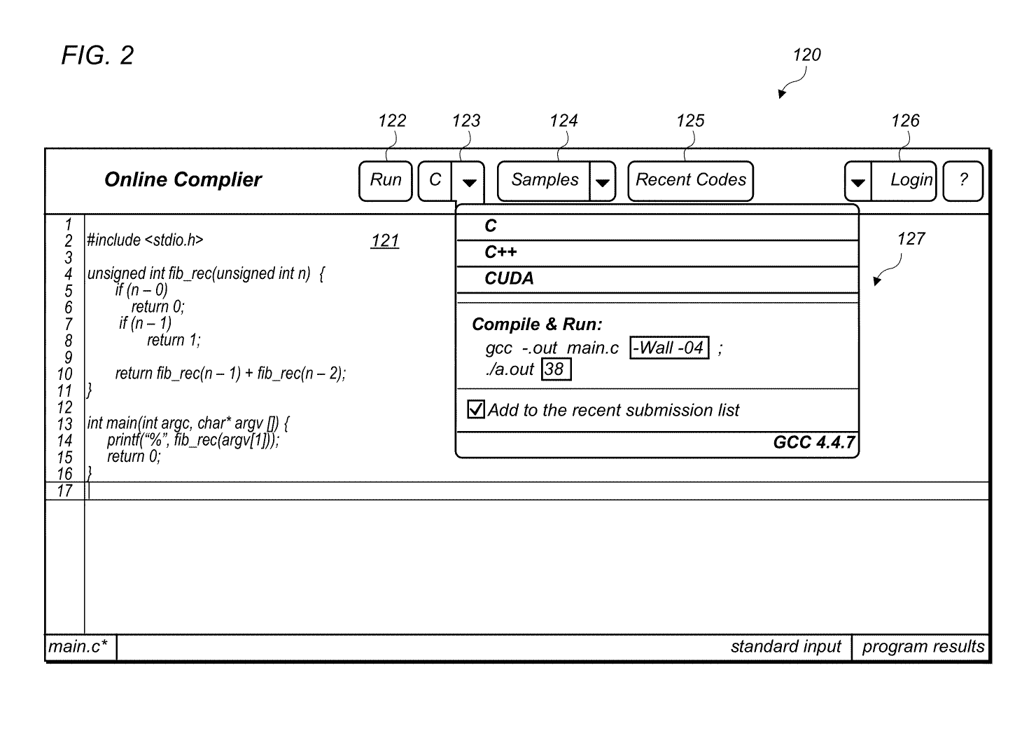

FIG. 2 illustrates one embodiment of a user screen display for compiling software. The software may include sets of program instructions that can be compiled and run by one or more development computing systems, such as are described herein.

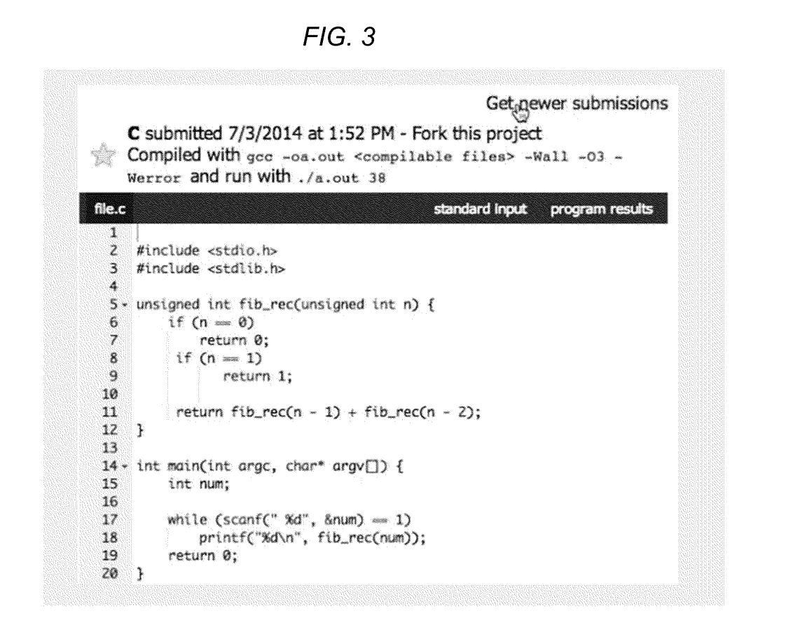

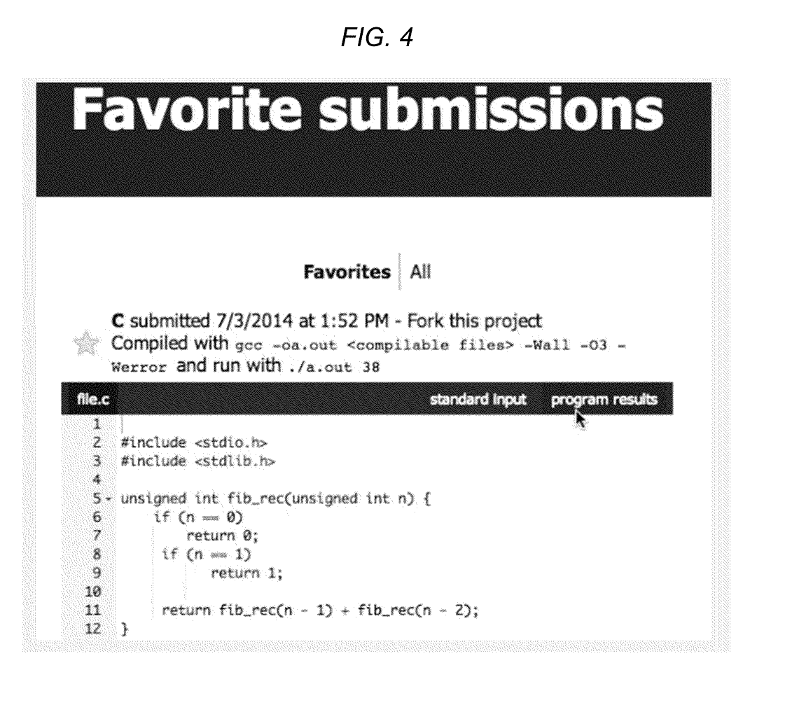

To enable community contribution and involvement, users may choose to share their experiences on reducing energy consumption of software by open-sourcing their code solutions. As shown in FIG. 2, user codes and their energy consumption results become publically available when “Add to the recent submission list” is checked. Others can duplicate the shared codes and download the corresponding power results at Recent Codes (125 in FIG. 2). FIG. 3 illustrates one embodiment of a user screen display for managing, displaying, and retrieving code submissions. FIG. 4 illustrates one embodiment of a user screen display for displaying and managing code submissions, including favorite submissions.

The particular code to be run and analyzed may be determined by the user, in some cases, the user may compile and run an entire program with multiple source code files. In other cases, the user may select a particular module, block, or segment of code to be analyzed.

In various embodiments, the hardware layer is integrated into the software layer that collects the power data from multiple sources and makes power profiling as a service. The cloud programming environment is supported with a dedicated scheduler that can support the low-level layers. The system provides tools that the software developer can use to improve the energy-efficiency of the programmer's code.

In some embodiments, a vertical hardware and software stack profiles the power consumption profile of running code. The system may also support the profiling of code uploaded to, and compiled on, cloud-based computers that emulate the real world conditions of user devices. The output can allow software developers to minimize the power consumption of their applications, which in turn can reduce costs.

In some embodiments, systems as described herein provide a cloud based compilation and analysis service. The system may collect information into a database that can be used for educating developers on best practices based on the collected data.

In some embodiments systems and methods as described herein are used to educate and gather data that can be used to develop best practices as hardware and software change. Applications include mobile phones, supercomputers, telecommunications systems, electronic commerce, industrial applications, and home computing devices.

Referring again to FIG. 2, display 120 include code listing 121, run button 122, compiler selection button 123, sample selection menu 124, recent codes button 125, and login button 126. Compiler selection button may activate compiler menu and status display 127. Code listing 121 may, at the user's selection, include code that has been created or edited by the user or code written by another user. This screen may be used to select one or more programs or blocks of code that are to be evaluated for energy efficiency,

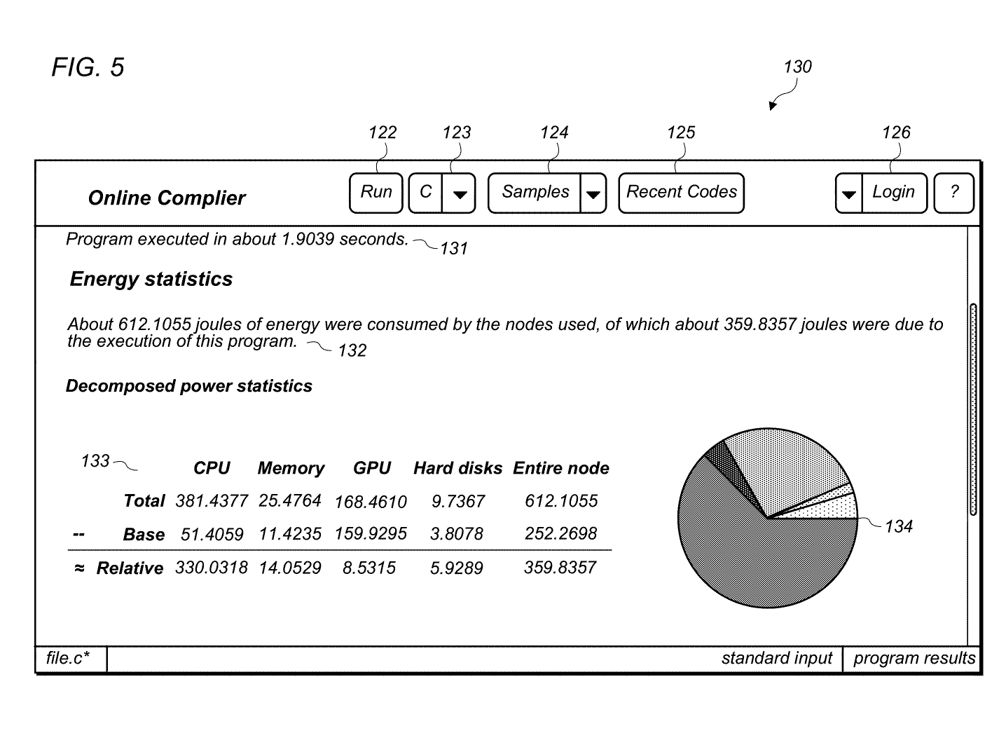

FIG. 5 illustrates one embodiment of a user screen display for assessing energy efficiency of software. Display 130 includes program execution information 131, energy statistics 132, and decomposed power statistics 133. Decomposed power statistics 133 includes a breakdown of energy by various components, as computing relative energy for each component and the entire node. In each case, relative energy is the difference between total energy and base energy. Results may be presented graphically, such as in pie chart 134. Controls for display 130 may be the same as those for display 120 described above relative to FIG. 2.

In various embodiments, a system for developing software includes power measurement and profiling subsystems. The power measurement and profiling subsystems may be easy-to-use. The power measurement subsystem may combine the power data from various sources, for power analysis. The power profiling subsystem controls may power meters for collecting, synchronizing and transferring power data, and provide power profiling as a service to users.

The power measurement system may include a sufficient number of channels for acquiring measurements on all computing components in a system running the code to be evaluated. In one embodiment, the power measurement system includes 32 or more channels. In another embodiment, the power measurement system includes 16 or more channels. In some embodiments, a power measurement system takes measurements of components that are connected to two or more independent power rails in a particular computer or server. In certain embodiments, the power measurement subsystem acquires power information of a large-scale computing cluster.

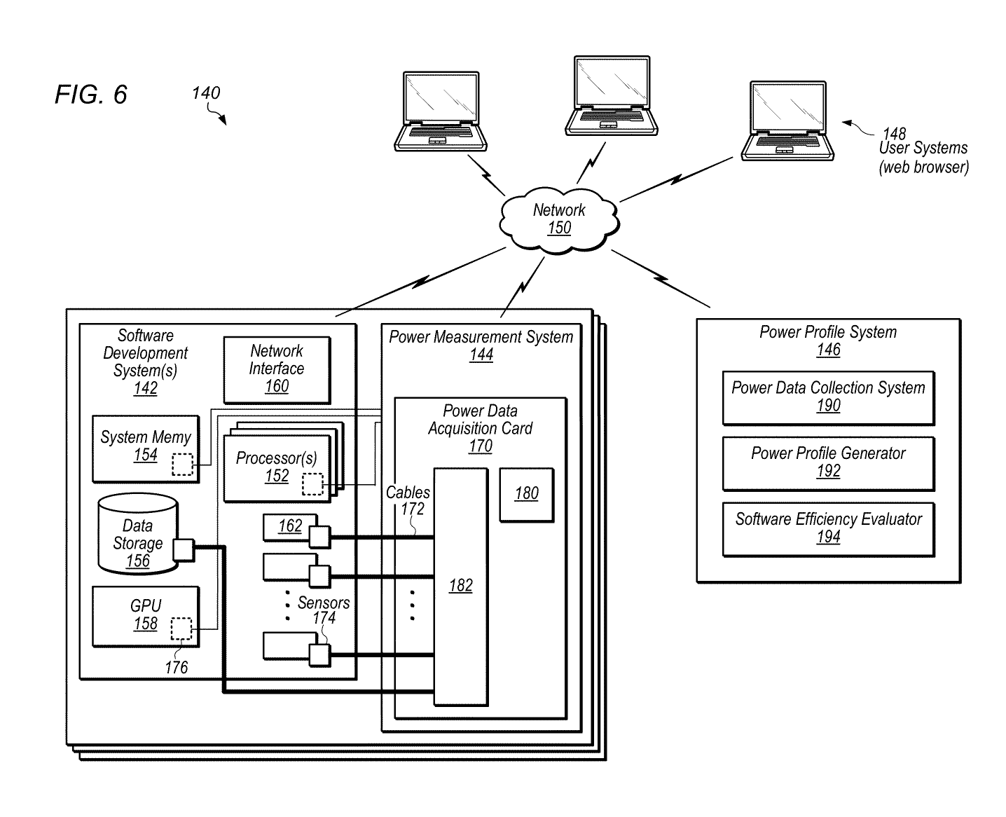

FIG. 6 illustrates one embodiment of network-based system for assessing software energy efficiency, System 140 includes software development systems 142, power measurement systems 144, power profile system 146, and user systems 148 (which may be web browsers, such as described above relative to FIG. 1). Software development systems 142, power measurement systems 144, power profile system 146, and user systems 148 are communicatively coupled by way of network 150. In some embodiments, user systems 148 access software development tools, power profiling, and efficiency evaluator in a cloud environment. Some or all of the elements may be provided as service in the cloud environment

Software development system 142 includes processors 152 (which may include one or more CPUs), system memory 154, data storage 156, graphic processor unit (GPU) 158/Intel Coprocessors (Xeon Phi), network interface card 160, and components 162. Any or all of these components may consume power during execution of computer code. Software may also be first written, edited, compiled, and run by users on systems 148. Then users can submit code to the described system for energy-efficiency analysis.

Power measurement system 144 includes power data acquisition card 170, cables 172, sensors 174. Sensors 174 may sense current or other characteristics of power of the components with which they are coupled. In some cases, on-board sensor is included in or attached to a computing component (e.g., on processor 152, system memory 154, and GPU 158). In other cases, power needs to be measured by one or more of sensors 174 that include numerous shunt resistors (as shown in power data acquisition card 170 and FIG. 5). Power information sensed by sensors 174 and on-board sensors 176 supply the power data of various components to the Power Data Collection System 190. In some embodiments, components 162 are supplied power from two or different power rails or other power supply components. Power data acquisition card 170 may include power acquisition central processing unit 180 and sensor interface 182.

Power profile system 146 includes power data collection system 190, power profile generator 192, and software efficiency evaluator 194. Power data collection system 190 may collect information from one or more power measurement systems, Power profile generator 192 may perform calculations and generate power profiles for sets of program instructions using information from power data collection system 190. Software efficiency evaluator 194 may provide information for assessing energy efficiency of the software code.

Once power data has been compiled and processed in power profile system 146, users on user systems 148 may access the information over network 150. Each user may login from various locations at any time using a web browser. Modifications to the computer code may be made based on the information provided by the power profile system, in some embodiments, power profile system 146 categorizes or classifies a computer program (or a segment or block of code) based on its energy efficiency, programming language, size, or other characteristics. The categorization can be used for determining improvements to efficiency of the code.

In some embodiments, a software efficiency evaluator determines recommendations based on power information acquired by the system. The recommendations may include, for example, changes to computer code to improve energy efficiency. In certain embodiments, recommendations are based on power data collection for multiple runs of a particular program or program type by multiple users.

In some embodiments, multiple users on the cloud collaborate to develop more efficient software using the power profile system. Collaborators may include, in one embodiment, a group of students.

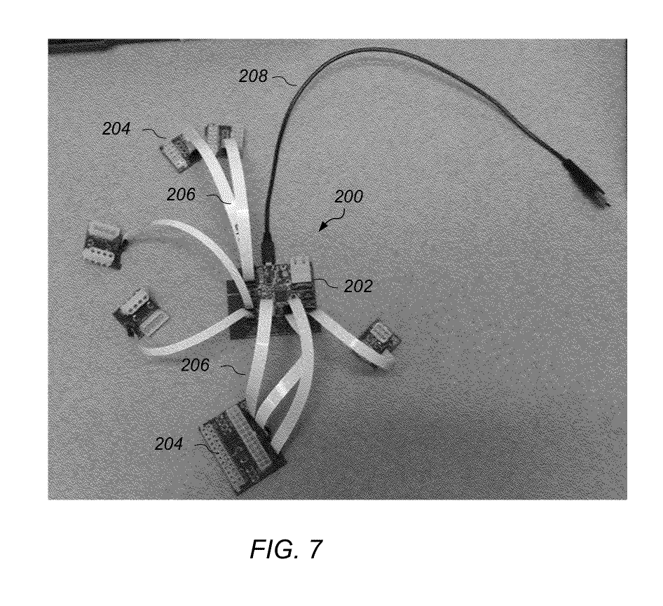

FIG. 7 illustrates one embodiment of a power data acquisition device. Power data acquisition device 200 includes power data acquisition card 202, connector boards 204, sensor cables 206, and input/output cable 208. Power data acquisition device 200 may be installed on one or more software development computing systems, such as one or more servers. Each of connector boards 204 may be coupled to a connector for one or more electrical components in a computing system that is used to execute software code to be evaluated via one or more of sensor cables 206. The power data acquisition card 202 may receive signals from sensors that measure power consumption or other characteristics of power during execution of computer code by the computing system.

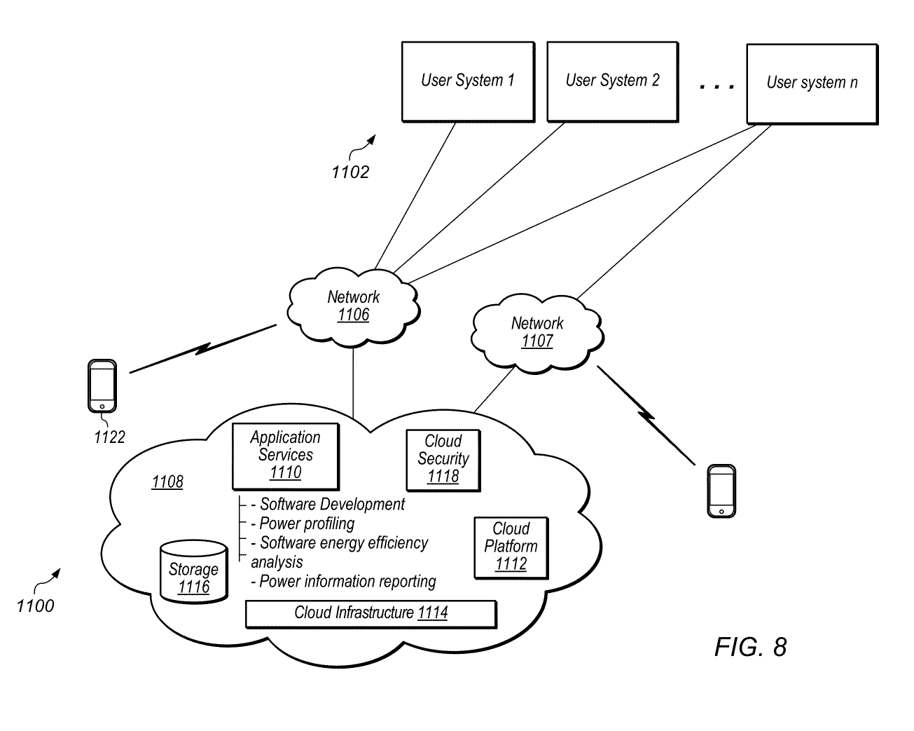

In some embodiments, software development, power collection, power profiling, and energy efficiency evaluation is provided by way of a cloud computing system over a communications network. FIG. 8 illustrates an embodiment of a cloud computing system that can be implemented in various embodiments. System 1100 includes user systems 1102. Each user system 1102 may be, in one embodiment, a device including a web browser. User systems 1102 may include a network of computing devices connected to network 1106. Each of user systems 1102 may be connected to cloud computing system 1108 by way of network 1106. In certain embodiments, user systems 1102 are connected to one another by way of network 1106.

Various system architectures may be employed in cloud computing system 1108. Systems and components of cloud computing system 1108 may be at a single physical location, such as a medical facility or data center, or distributed among any number of locations.

Cloud computing system 1108 includes cloud application services 1110, cloud platform 1112, cloud infrastructure 1114, cloud data storage 1116, and cloud security 1118. Cloud applications services may be implemented by way of one or more computer systems, each include one or more central processing units, such as described herein. Examples of application services 1110 include providing remote software writing, editing, and compiling tools, power data collection services, collaborative software development tools, power profiles, energy efficiency reports, and software improvement recommendations. Cloud application services 1110 may access cloud data storage 1116.

Cloud infrastructure 1114 may encompass a variety of physical resources, such as computing devices, servers, block storage, mass storage devices, file servers, software, and network systems. In some embodiments, a cloud computing system encompasses virtualized resources, such as virtualized data storage or virtualized hardware.

In some embodiments, a service provider provides services to users (e.g., students, instructors, or other software developers) by way of cloud computing resources. In some embodiments, computation resources are rented or leased to customers of the service provider. In certain embodiments, services are provided to users at sites as software as a service (“SaaS”) or platform as a service (“Paas”). Services may be provided to each user on an on-demand basis.

In various embodiments, some users may be connected over a different network than other users. For example, as shown in FIG. 8, users may be connected to cloud computing system 1108 over network 1107. In some embodiments, one or more users are connected over a private network. For example, in the embodiment shown in FIG. 8, network 1106 may be a public network and network 1107 may be a private network.

Although for illustrative purposes only three user systems are shown in FIG. 8, a system may include any number of site computer systems at any number of locations.

Computer systems (which includes computing devices) may, in various embodiments, include components such as a CPU with an associated memory medium such as Compact Disc Read-Only Memory (CD-ROM). The memory medium may store program instructions for computer programs. The program instructions may be executable by the CPU. Computer systems may further include a display device such as monitor, an alphanumeric input device such as keyboard, and a directional input device such as mouse. Computer systems may be operable to execute the computer programs to implement computer-implemented systems and methods. A computer system may allow access to users by way of any browser or operating system.

A computing system may include, and/or may be implemented as, multiple functional modules or components, with each module or component including one or more resources (e.g., computing resources, storage resources, database resources, etc.). A system may include more or fewer components or modules, and a given module or component may be subdivided into two or more sub-modules or subcomponents. Also, two or more of the modules or components can be combined.

Computer systems may include a memory medium on which computer programs according to various embodiments may be stored. The term “memory medium” is intended to include an installation medium, e.g., Compact Disc Read Only Memories (CD-ROMs), a computer system memory such as Dynamic Random Access Memory (DRAM), Static Random Access Memory (SRAM), Extended Data Out Random Access Memory (EDO RAM), Double Data Rate Random Access Memory (DDR RAM), Rambus Random Access Memory (RAM), etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to implement embodiments as described herein. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU executing code and data from the memory medium may include a means for creating and executing the software program or programs according to the embodiments described herein.

As used herein, a “set of program instructions” includes any computer program, code, or segment, portion, or module thereof.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

1. A system for developing software, comprising:
one or more software development computing systems, each of at least one of the software development computing systems configured to execute sets of program instructions;
one or more power measurement systems comprising one or more sensors configured to measure characteristics associated with electrical power consumption by components of at least one of the software development computing systems during execution of sets of program instructions;
one or more power data collection systems coupled to at least one of the power measurement systems and configured to collect power information from the power measurement systems; and
an energy efficiency evaluation system configured to provide a measure of efficiency of execution of at least one set of program instructions executed on at least one of the software development computing systems based on power information from the at least one of the power data collection systems.

2. The system of claim 1, wherein the system comprises:
a hardware layer, wherein the power measurement system is included in the hardware layer;
a power profile layer, wherein the power data collection system is included in the power profile layer, wherein the power profile layer further comprises one or more power profile generator devices configured to generate power profiles based at least in part on measurements taken of power consumption during execution of sets of program instructions on the software development computing systems; and
a cloud programming layer, wherein the cloud programming layer is configured to support users editing, compiling, and/or running, by way of a web browser, sets of program instructions on at least one of the software development computing systems.

3. The system of claim 1, further comprising:
a power profile generator configured to:
receive, from the power measurement system, measurements of power consumption by at least one computing system during execution of at least one set of program instructions; and
generate one or more power profiles based at least in part on the measurements.

4. The system of claim 3, wherein the power profile generator device is configured to provide power profiling as a service to one or more users.

5. The system of claim 1, wherein at least one of the power data measurement systems comprises a power data acquisition card comprising one or more circuits configured to detect power consumption in at least one of the computer systems, wherein the power data collection circuit board is coupled to a plurality of components used to execute one or more of the sets of program instructions by one or more cables.

6. The system of claim 1, wherein the system is configured to determine an amount of energy used for at least one set of program instructions.

7. The system of claim 1, wherein at least one of the set of program instructions is a block or module of code.

8. A system, comprising:
a power measurement system comprising one or more measuring devices configured to measure electrical power consumption during execution of a set of program instructions on one or more computing systems;
a power profile generator configured to:
receive, from the power measurement system, measurements of power consumption information by at least one computing system during execution of at least one set of program instructions; and
generate one or more power profiles based at least in part on the measurements.

9. The system of claim 8, wherein the set of instructions is a block of computer code from a computer program under development.

10. The system of claim 8, wherein at least one of the power profiles comprises a computation of the amount of energy consumed by at least device during execution of at least one set of program instructions.

11. The system of claim 8, further comprising an energy efficiency assessment component configured to determine at least one measure of energy efficiency.

12. The system of claim 8, wherein the system is configured to determine an amount of energy used for at least one set of program instructions.

13. The system of claim 8, wherein at least one of the set of program instructions is a block or module of code.

14. The system of claim 8, wherein at least one of the measurement devices comprises a power data acquisition card comprising one or more circuits configured to detect power consumption in at least one of the computer systems, wherein the power data acquisition card is coupled to a plurality of components used to execute one or more of the sets of program instructions by one or more cables.

15. The system of claim 8, wherein at least one of the measurement devices comprises an on-board power sensor in a device used to execute at least a portion of the set of program instructions.

16. The system of claim 8, wherein at least one of the measurement devices comprises a power data acquisition card comprising one or more circuits configured to detect power consumption in at least one of the computer systems, wherein the power data acquisition card is coupled to a plurality of components used to execute one or more of the sets of program instructions by one or more cables, and wherein at least one of the measurement devices comprises an on-board power sensors in a device used to execute at least a portion of the set of program instructions.

17. The system of claim 8, wherein the system is configured to support users editing, compiling, and/or running, by way of a web browser, sets of program instructions on at least one of the software development computing systems.

18. (canceled)

19. The system of claim 8, wherein the system is configured to determine at least one measure of energy efficiency make at least one recommendation to improve energy efficiency of executing the program instructions.

20. The system of claim 8, wherein the system is configured to categorize one or more blocks of computer code based at least in part on at least one of the measurements of power consumption during execution of the code.

21-22. (canceled)

23. A method of assessing energy efficiency of executing software, comprising:
measuring, by one or more power measurement systems coupled to one or more computing systems, one or more characteristics of electrical power consumed by one or more components during execution of a set of program instructions by each of at least one of the computing systems; and
determining, based at least in part on the measurements, a power profile associated with the execution of at least one of the set of program instructions by at least one of the computing systems, wherein the power profile comprises a measure of power consumed by execution of at least a portion of the set of program instructions.

24-31. (canceled)
